(19) United States
(12) Patent Application Publication
(10) Pub. No.: US 2002/0047062 A1
(43) Pub. Date: Apr. 25, 2002

(54) Granulator

(76) Inventors: Robert J. Keskula, Holden, MA (US); Andrew H. Casavant, N. Smithfield, RI (US); Kenneth A. Focht, Needham, MA (US)

Correspondence Address: DICKSTEIN SHAPIRO MORIN & OSHINSKY LLP, 2101 L STREET NW, WASHINGTON, DC, 20037-1526, US

(21) Appl. No.: 09/878,408

(22) Filed: Jun. 12, 2001

Related U.S. Application Data
(60) Provisional application No. 60/210,907, filed on Jun. 12, 2000.

(51) Int. Cl. B02C 18/18

(52) U.S. Cl. 241/294

(57) ABSTRACT

An apparatus is provided for processing (e.g., granulating) industrial materials (e.g., synthetic resin materials). The apparatus has a rotor shaft mounted in the inside of a housing. The rotor shaft has an axis running in a generally horizontal direction. Cutters extend radially from the rotor shaft with some of the cutters extending a distance less than the others. Approximately one-half of a second plurality of cutters are positioned on the rotor shaft between a first cutter and a second cutter of the first plurality of cutters, and approximately the other half of the second plurality of cutters are positioned on the rotor between the second cutter and a third cutter of the first plurality of cutters. The cutters may contain a symmetrical blade portion such that the rotor may be run in both directions, thereby extending the time between required maintenance operations, and minimizing down-time for the apparatus.

This application claims the benefit of U.S. Provisional Patent Application Ser. No. 60/210,907, filed on Jun. 12, 2000, the entire contents of which are incorporated herein by reference.

### BACKGROUND

The present invention relates in general to material processing apparatuses, including material granulators. More specifically, it relates to a material granulator having multiple cutting blades.

A typical granulator apparatus (e.g., such as that used in the manufacturing of industrial plastics) is made up of: i) a hopper (for temporarily holding and feeding the industrial material to be granulated; ii) a granulator blade portion which receives the industrial material from the hopper and contains the granulator rotor and blades; and iii) a storage portion for storing the granulated material. Such granulators typically have an integral granulator motor coupled to the granulator blade portion for transferring energy to the granulator blades.

One example of a known crushing apparatus is depicted in FIG. 14. The apparatus has a material hopper 12, a crushing chamber 14 and an opening 13 through which the crushed material is allowed to drop. The crushing chamber contains two rotor shafts 17 and 18, each of which support multiple cutting blades 19 and 20. The top set of cutting blades 19 are larger than the lower set of cutting blades 20. Accordingly, the top set of cutting blades 19 are used for roughly crushing the material and the lower set of cutting blades 20 are used for finely crushing the material. During operation, the material drops from the hopper portion 12 into the crushing chamber 14, where it is roughly crushed by the large blades 19. The roughly crushed material then drops to the smaller cutting blades 20 where it is finely crushed. The finely crushed material then drops down through the opening 13. The FIG. 14 crushing apparatus, although somewhat effective, has been found to be unduly large and bulky due to its two-tiered blade configuration. In addition, since two rotor shafts are required, it follows that two rotor drives must be powered. Thus, the cost to operate the FIG. 14 crushing apparatus, along with its prohibitively large size, render its use less than ideal.

One proposed improvement over the FIG. 14 crushing apparatus is found in the crushing apparatus depicted in FIGS. 15-17. The crushing apparatus of FIGS. 15-17 contains a single driving shaft 37 requiring a single power source for driving the shaft 37. In addition, it contains two differently-sized blades 41 and 42 that are commonly mounted on the single driving shaft 37. The differently-sized blades are made up of two large saw-tooth blades 41 used for roughly crushing the material and a multitude of small saw-tooth blades 42 used for finely crushing the material. The crushing apparatus of FIGS. 15-17 also includes two cover members 43 used for capturing any roughly crushed material that has been crushed by the large blades 41, but has not yet been crushed by the small blades 42. Since the material must be finely crushed before it is permitted to drop into the dropping opening 33, the cover members along with the large blades 41 provide a means with which the roughly crushed material is scooped up and brought back into the crushing chamber 32 where it may be finely crushed by the small blades 42. In addition, the crushing apparatus contains two sidewalls 32 that are generally perpendicular to the axis of the drive shaft 37. Furthermore, the small saw-tooth blades 42 are located on either side of the drive shaft 37 between respective ones of the large saw-tooth blades 41 and the sidewalls.

A problem associated with the crushing apparatus of FIGS. 15-17 is that the multitude of blades 41 and 42 are affixed to the driving shaft 37 in a manner such that even if only a single blade (e.g., one of the large blades 41) requires replacement (e.g., due to damage, regular maintenance, etc.), the entire blade assembly must be dismantled in order to reach the blade that requires replacement. That is, all of the large saw-tooth blades 41 and all of the small saw-tooth blades 42 located adjacent to the damaged blade must be removed in order to replace only the one damaged blade.

Furthermore, since the blades 41 and 42 are saw-toothed in shape, the drive shaft 37 may be rotated in only one direction; i.e., the direction in which the blades are effective for cutting the material. The fact that the blades are useful for cutting in only a single direction means that they have a relatively short useful life; thus, they will require frequent replacement. In addition, the fact that only one set of blades 41 is provided for roughly crushing the material means that the small blades 42 are expected to finely crush material that had been subject to only one crushing operation; thus, replacement of the small blades due to damage is likely to be more frequent. Consequently, not only is the crushing apparatus of FIGS. 15-17 unduly burdensome and expensive to maintain from purely a labor standpoint, but it can be rendered useless for long periods of time while the blade assembly is dismantled, the damaged blade is replaced and the blade assembly is re-assembled during frequently required routine maintenance.

In addition, since the sidewalls of the FIG. 15 crushing apparatus are generally perpendicular to the drive shaft, they are not useful for steering the material into the small blades 42. Moreover, since any material that enters the FIG. 15 crushing apparatus will be large pieces of uncrushed material, they are likely to become trapped in between the generally perpendicular sidewalls and the large cutting blades 41, unable to be crushed by the small blades 42. This presents a problem in that the small blades 42 will likely become worn more quickly as a result of constantly attempting to break down large pieces of material while the material is trapped between the generally perpendicular sidewalls and the large blades 41.

### SUMMARY

The present invention provides an apparatus for processing industrial materials.

The invention also relates to a three-blade granulator apparatus, a rotor shaft and blade assembly, and a method for removing and replacing damaged blades on the rotor shaft and blade assembly. In general, the apparatus may be used to granulate, cut, shred, crush, comminute or otherwise process a variety of materials, including but not limited to synthetic resin materials. The granulator apparatus has a rotor shaft mounted in the inside of a housing. The rotor shaft has an axis running in a generally horizontal direction. A first and second plurality of cutters extend radially from the rotor shaft with each of the second plurality of cutters extending a distance less than each of the first plurality of cutters. In one embodiment, approximately one-half of the second plurality of cutters are positioned on the rotor shaft between a first cutter and a second cutter of the first plurality of cutters and approximately the other half of the second plurality of cutters are positioned on the rotor between the second cutter and a third cutter of the first plurality of cutters. Each of the cutters contains a symmetrical blade portion such that the rotor may be run in both directions, thereby extending the time between required maintenance operations, and minimizing down-time for the apparatus. Furthermore, when blade replacement is required, the damaged blade may be removed and replaced without disrupting the balance of the rotor shaft and blade assembly.

In one aspect, a fractional cutter portion is provided which contains at least one cutter blade portion symmetrical in shape. The fractional cutter portion is easily coupled to and decoupled from a rotor shaft of a granulator apparatus.

In another aspect, a cutting tooth assembly is provided which contains a plurality of symmetrical cutting teeth and which is easily coupled to and detached from a rotor shaft of a granulator apparatus.

In another aspect, a rotor shaft and blade assembly is provided which contains a plurality of fractional cutter portions and a plurality of cutting tooth assemblies.

In another aspect, an improved granulator apparatus is provided containing an improved rotor shaft and blade assembly.

In another aspect, an improved cutting chamber frame is provided which is easily assembled and which contains at least one slanted sidewall. The slanted sidewall assists in feeding a material to be crushed into at least one of a first plurality of cutters.

In another aspect, an improved blade system is provided which contains at least three identical cutter discs assembled on a hexagonal shaft, wherein each cutter disc may further contain at least two portions that join together on the hexagonal shaft, wherein each cutter disc contains a plurality of cutting teeth, and wherein when the three cutter discs are mounted on the hexagonal shaft, the orientation of the cutting teeth for each blade with respect to the hexagonal shaft form a staggered pattern of at least three distinct cutter teeth orientations on the hexagonal shaft.

The invention also relates to a method of replacing a defective cutter in a granulator apparatus.

The invention also relates to a method of operating a granulator apparatus.

These and other features and advantages of the invention will be more clearly understood from the following detailed description and drawings of preferred embodiments of the present inventions.

### BRIEF DESCRIPTION OF THE DRAWINGS

FIG. 1 is a perspective view of a granulator apparatus according to a preferred embodiment of the present invention.

FIG. 2 is an exploded view of a cutting chamber frame of the apparatus of FIG. 1.

FIG. 3 is a bottom perspective view of the cutting chamber frame of FIG. 2.

FIG. 4 is a top perspective view of the cutting chamber frame of FIG. 2.

FIG. 5 is an exploded view of a rotor shaft assembly within the cutting chamber frame of FIG. 2.

FIG. 6 is another exploded view, like FIG. 5, showing the rotor shaft assembly located within the cutting chamber frame.

FIG. 7 is an exploded view of the rotor shaft and blade assembly of FIG. 5.

FIG. 8 is a plan view of the rotor shaft and blade assembly of FIG. 5.

FIG. 9 is a view taken along line IX-IX of FIG. 8.

FIG. 10 is view taken along line X-X of FIG. 8.

FIG. 11 is a view taken along line XI-XI of FIG. 8.

FIG. 12 is a view like FIG. 9 showing a cover member. Portions of elements that are hidden from view by the cover member are shown in the figure in phantom lines.

FIG. 13 is a view like FIG. 11 showing a cover member.

FIG. 14 is a known crushing apparatus.

FIGS. 15-17 are three views of a known crushing apparatus.

FIG. 18 is a perspective view of an assembled granulator.

FIG. 19 is a perspective view of a cutting chamber according to another preferred embodiment of the invention.

FIG. 20 is a perspective view of a rotor shaft assembly of the FIG. 19 cutting chamber.

FIG. 21 is an exploded view of a portion of the FIG. 20 rotor shaft assembly.

FIG. 22 is a cross sectional view taken along line XXII of FIG. 19.

FIG. 23 is a plan view of a small cutter blade according to another embodiment of the invention.

### DETAILED DESCRIPTION OF PREFERRED EMBODIMENTS

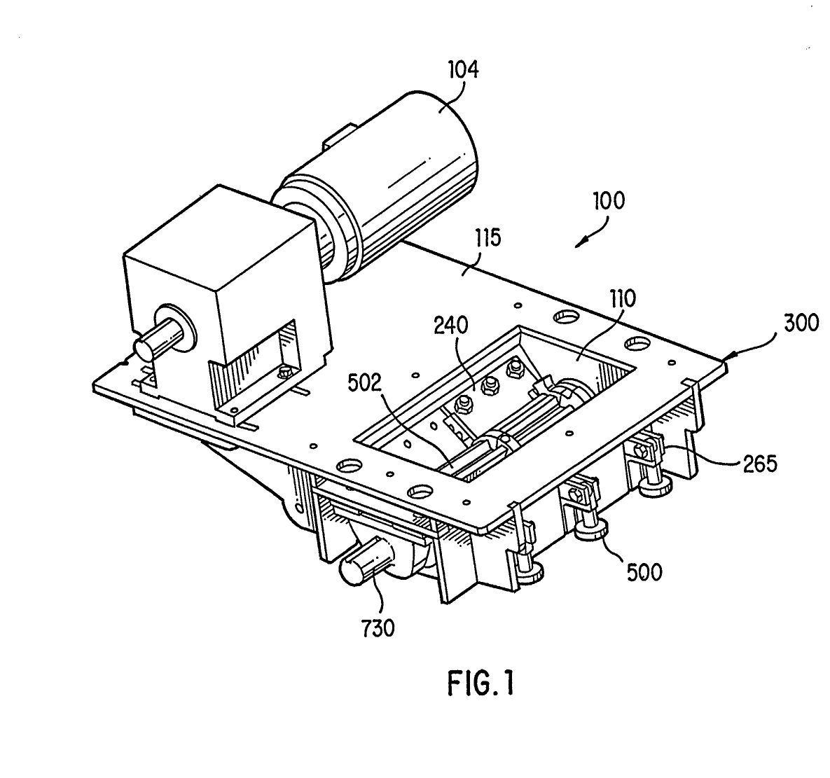

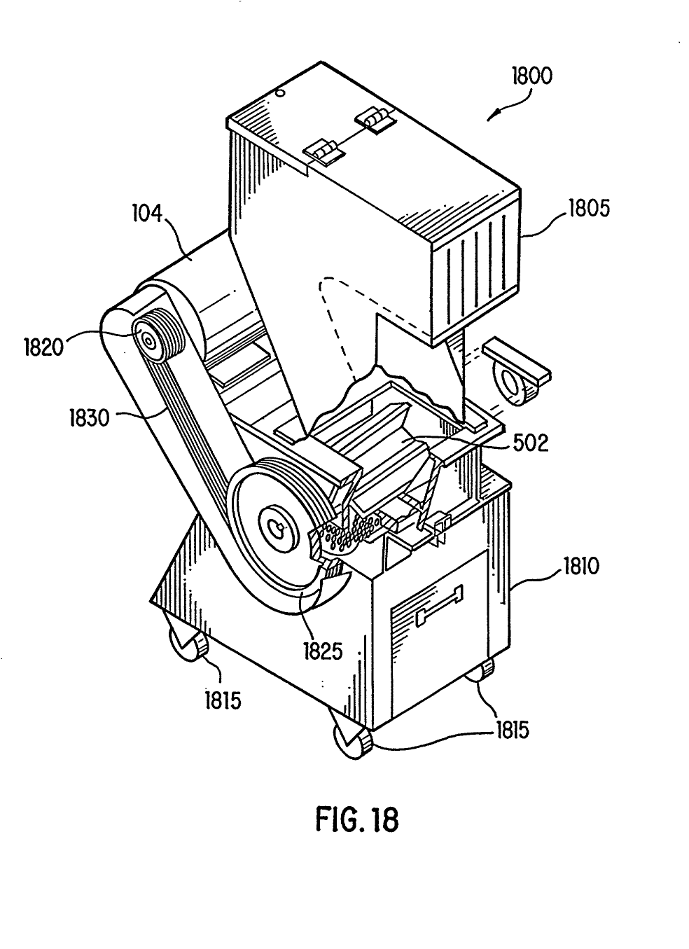

FIG. 1 is a perspective view of a granulator apparatus 100 in accordance with a preferred embodiment of the invention. The granulator apparatus 100 contains a cutting chamber frame 300 having an interior portion 110 and an exterior portion 115, and a rotor shaft and blade assembly 502 located in the interior portion 110 of the cutting chamber frame 300, which will be described in greater detail below. The granulator apparatus 100 also includes a granulator motor 104 for rotating the rotor shaft and blade assembly 502 when the two are coupled together, such as, for example, using pulleys and a drive belt (e.g., 1820, 1825 and 1830, as in FIG. 18).

The rotor shaft and blade assembly 502 is located in the interior portion 110 of the cutting chamber frame 300 for granulating solid material as it is fed from a hopper (1805 of FIG. 18) that would have its bottom-most portion positioned to feed (e.g., gravity feed) material into the interior portion 110 of the granulator apparatus 100. A storage portion (1810 of FIG. 18) would normally be located below the interior portion 110 and the rotor shaft and blade assembly 502 to receive and temporarily store the granulated material. A fully assembled granulator may also contain wheels 1815 on the bottom of e.g., its storage portion 1810, thereby providing a degree of mobility.

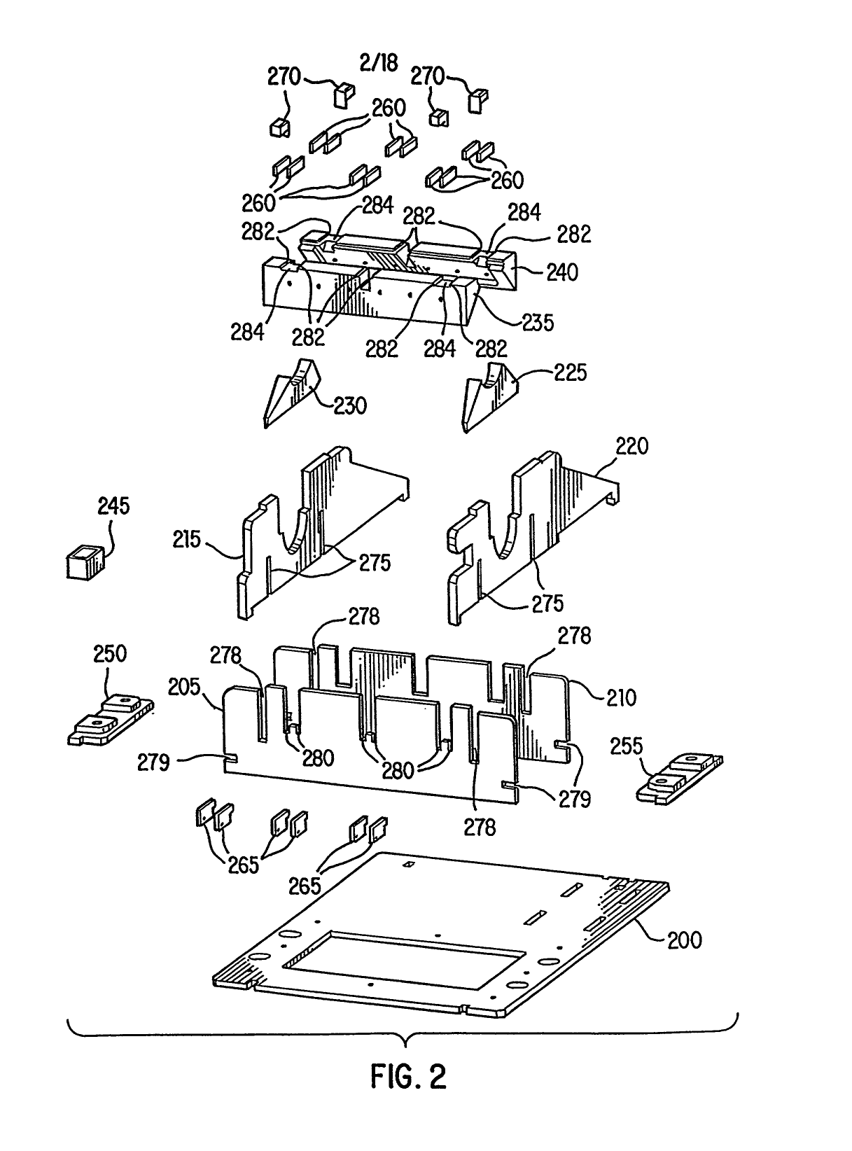

Referring to FIG. 2, an exploded view of a cutting chamber frame 300 according to a preferred embodiment of the invention will now be described. A top chamber plate 200 is depicted along with two bearing pads 250 and 255 and six scallop clamping blocks 265 at a lowermost portion of FIG. 2. Also depicted are a front chamber plate 205 and a rear chamber plate 210. Just above that are a right chamber plate 215 and a left chamber plate 220. To the left of the right chamber plate 215 (as viewed in FIG. 2) is a spring block 245. Just above the right and left chamber plates 215 and 220 are a first slanted side plate 230 and a second slanted side plate 225. Just above the slanted side plates 230 and 225 are comb holders 235 and 240. Above the comb holders 235 and 240 are twelve comb holder gussets 260. Just above the comb holder gussets 260 are four filler gussets 270.

As can be seen, the right and left chamber plates 215 and 220 are equipped with slots 275 which are insertable within corresponding slots 278 of the front and rear chamber plates 205 and 210. Bearing pads 250 and 255 are inserted into slots 279 of front and rear chamber plates 205 and 210. Similarly, each of the six scallop clamping blocks 265 are respectively insertable within six slots 280 of front chamber plate 205. Comb holders 235 and 240, in addition to slanted side plates 230 and 225, form the chamber within which a rotor shaft assembly (not shown in FIG. 2) will sit. Similarly, each of the twelve comb holder gussets 260 are respectively insertable within twelve slots 282 of comb holders 235 and 240. Each of the four filler gussets 270 are respectively insertable within each of the four slots 284 defined within comb holders 235 and 240.

The top chamber plate 200 is preferably formed of one-half-inch thick steel. The left and right chamber plates 215 and 220 are preferably formed of five-eighths-inch thick steel. The front and rear chamber plates 205 and 210 are preferably formed of one-half-inch thick steel. Once the plates have been assembled as described above, they are welded (e.g., stitch welded, full fillet welded, etc.) together to form its box-shaped cross-sectional, modular construction.

It should be noted that the modularity of the cutting chamber frame 300 easily enables the customization of a granulator apparatus 100. For example, if a particular industrial material (to be crushed) calls for a rotor shaft longer than the rotor shaft 730 shown in FIG. 1, many of the components shown in FIG. 2 may still be used, thus, enabling mass production of those component parts (e.g., left and right chamber plates 215 and 220) that can be used with granulator apparatuses 100 having different rotor 730 lengths.

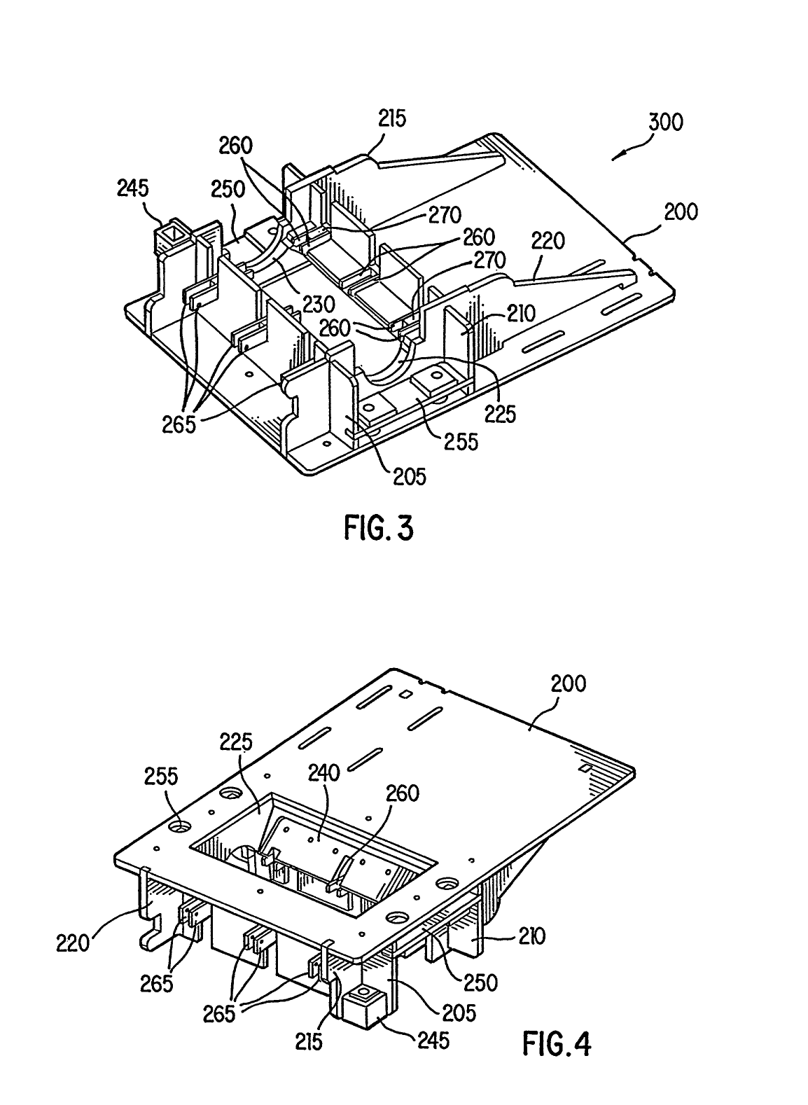

Turning now to FIG. 3, a bottom perspective view of the cutting chamber frame of FIG. 2 is depicted. FIG. 3 is a view of the FIG. 2 cutting chamber frame 300 filly assembled. Throughout this specification, like reference numerals designate like components.

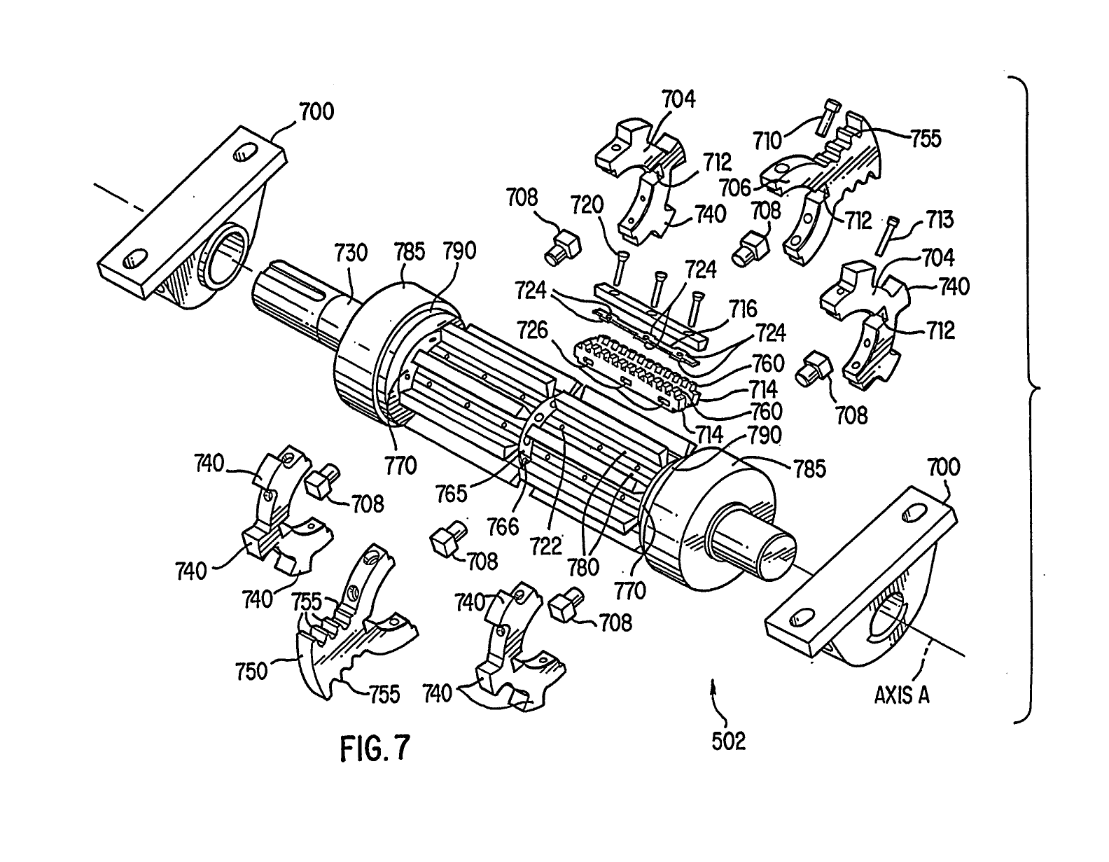

FIG. 4 depicts a top perspective view of the cutting chamber frame 300. The FIG. 4 perspective view is a 180° rotated view of the FIG. 3 perspective view. It should be noted that slanted sidewall 225 (and slanted sidewall 230, opposite sidewall 225, but not visible in FIG. 4) is intended to provide a guide for helping to feed uncrushed material received from e.g., hopper 105 into the medium cutter blade portions 740 (not shown in FIG. 4), as will be described in more detail below. In order for the sidewalls 225 and 230 to provide such a feeding function, the sidewalls 225 and 230 are not perpendicular to the axis A of the rotor shaft 730 (of FIG. 7). Rather, the sidewalls 225 and 230 are skewed from being perpendicular to the axis A, preferably from approximately ten degrees to approximately twenty degrees. As shown in the illustrated embodiments, the sidewalls 225 and 230 are skewed fifteen degrees from being perpendicular to the axis A.

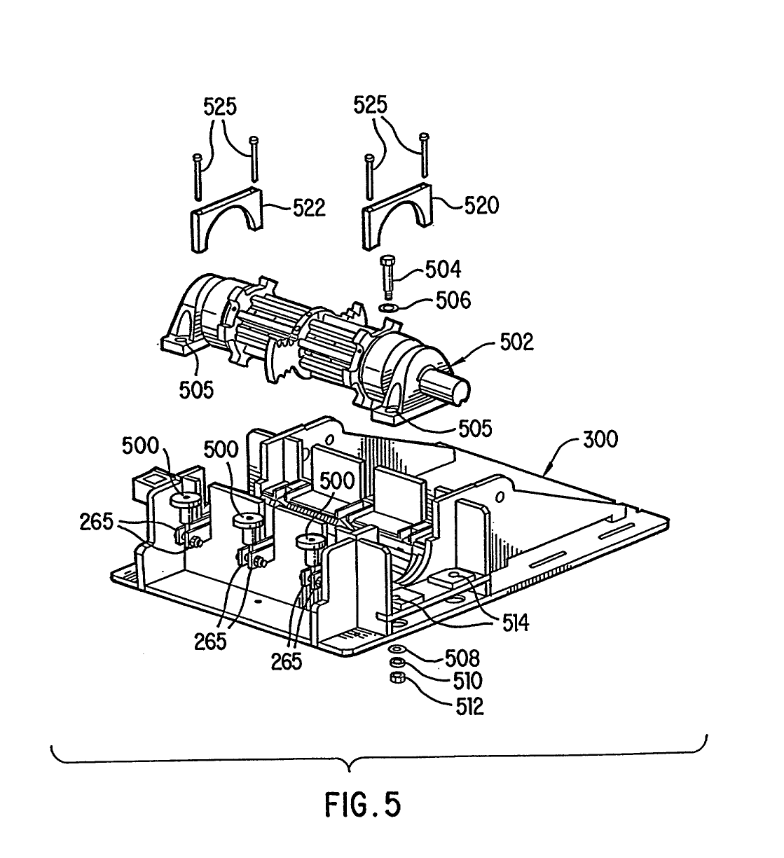

Turning now to FIG. 5, an exploded view of a rotor shaft assembly 502 within the cutting chamber frame 300 is depicted. Rotor shaft and blade assembly 502 is affixed to the cutting chamber frame 300 with, among other things, four bolts 504 that are insertable within four mounting holes 505 of the rotor shaft and blade assembly 502. Additionally, the bolt 504 is inserted within the mounting hole 514 of the cutting chamber frame 300. Two washers 506 and 508, a lock washer 510 and a nut 512 are used in four places to mount the rotor shaft and blade assembly 502 to the cutting chamber frame 300.

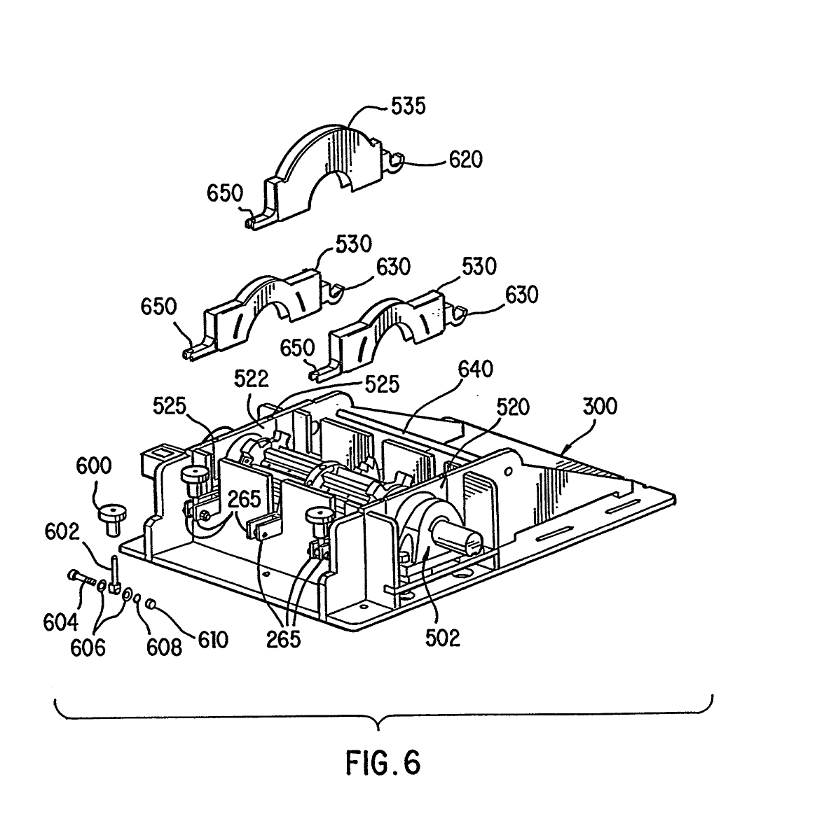

Also depicted are three knob assemblies 500 on a front bottom portion of the cutting chamber frame 300. Each knob assembly 500 is mountable within respective pairs of scallop clamp blocks 265 as will be described in greater detail in connection with FIG. 6. Also depicted in the FIG. 5 exploded view are a left rotor insert 520 and a right rotor insert 522, each being mounted adjacent to the rotor shaft and blade assembly 502 and each serving as a shield to help prevent material from escaping from the interior portion 110 of the granulator apparatus 100 as it is being granulated. Left and right rotor inserts 520 and 522 are held to the cutting chamber frame 300 with four socket head cap screws (SHCSs) 525.

Turning now to FIG. 6, an exploded view of cover members within the cutting chamber assembly of FIG. 5 is depicted. The rotor shaft and blade assembly 502 is shown as being assembled within the cutting chamber frame 300. Left and right rotor inserts 520 and 522 are held in place with SHCSs 525 in four places. Each iron knob assembly 500 (of FIG. 5) consists of an knob 600, a bolt 602, the bolt 602 being insertable within the knob 600. A hex bolt 604 is insertable within the washers 606, a bolt 602, a lock washer 617 and held in place with a hex nut 610. The hex bolt 604 is insertable within the aligned holes of a pair of scallop clamp blocks 265.

Above the assembled cutting chamber frame 300 and the rotor shaft and blade assembly 502 are three cover members; two medium cover members 530 (left and right) and one large cover member 535. Each one of the cover members 530 and 530 and 535 is associated with a respective one of three cutting blades of the rotor shaft and blade assembly 502, as will be described below in more detail.

Also depicted between the right and left chamber plates 215 and 220, is a mounting shaft 640. Mounting shaft 640 extends most of the length of the rotor shaft and blade assembly 502. The three cover members 530, 530 and 535 are affixed to the mounting shaft 640 via their three mounting hooks 630, 630 and 630. The opposite sides of the three cover members 530, 530 and 535 are respectively coupled to each iron knob assembly 500 such that a respective bolt 604 is inserted within each slot 650 of the cover members 530, 530 and 535.

Referring now to FIG. 7, an exploded view of the rotor shaft and blade assembly 502 is depicted. A perspective view of a rotor shaft 730 is depicted as being rotatable about an axis A. A right side of the rotor shaft 730 is insertable within a right pillow block bearing 700 and a left side of the rotor shaft 730 is insertable within a left pillow block bearing 700. Two large cutter half portions 706 are depicted as being insertable within the shaft portion 765, located at a central point of the rotor shaft 730. Large cutter half portions 706 are mountable onto rotor shaft 730 in predetermined locations which are determined by the mounted location of cutter drive keys 708. The cutter drive keys 708 are inserted into the shaft portions 766 in two places. The two large cutter half portions 706 are respectively positioned on top of each cutter drive key 708 via a recess portion 712 such that the large cutter half portions 706 are always mounted on the rotor shaft 730 in a predetermined manner.

Each large cutter half portion 706 is screwed to rotor shaft 730 with four large SHCSs 710 (for a total of eight large SHCSs 710). Each cutter half portion 706 contains a symmetrical large blade portion 750. In addition, each symmetrical blade portion 750 contains four cutting ridges 755 on each side.

Still referring to FIG. 7, two pair of medium cutter halves 704 are located near opposite outer edges of rotor shaft 730. Each medium cutter half 704 contains three medium blade portions 740 for a total of six medium blade portions 740 per each medium cutter. Similarly to large cutter blade portions 750, each medium blade portion 740 is symmetrical. In addition, each medium cutter half 704 is mountable to rotor shaft 730 at shaft portions 770 with a cutter drive key 708 at four places, thus, ensuring that medium cutter halves 704 are mounted in a predetermined manner onto rotor shaft 730.

Each medium cutter half 704 is held in place with four medium SHCSs 713. Each medium cutter half 704 requires four medium SHCSs 713 for a total of sixteen medium SHCSs 713.

Referring now to the center portion of FIG. 7, a pair of multiple cutter assemblies in the form of small cutter rails 714 is depicted. Each small cutter rail 714 contains eleven cutting teeth 760. Each small cutter rail 714 is insertable onto a corresponding shaft portion 780. Cutter retaining plate 716 is insertable between each pair of small cutter rails 714 in a manner such that the flange portions 724 are inserted within cutter rail receptacles 726 at six places. A cutter retaining wedge 718 is positioned on top of the cutter retaining plate 716. Three wedge retaining screws 720 are used to affix each pair of small cutter rails 714 to the rotor shaft 730 via three small cutter mounting holes 722. There are a total of forty-eight such small cutter mounting holes 722 on the rotor shaft 730 enabling sixteen pair of small cutter rails 714 to be affixed to the rotor shaft 730.

A fully assembled rotor shaft and blade assembly 502 of the illustrated embodiment includes thirty-two small cutter rails 714, each of which contain 11 cutting teeth 760. In addition, a fully assembled rotor shaft and blade assembly 502 contains twelve medium cutter blade portions 740 and two large cutter blade portions 750. The present invention should not be limited, however, to the details of the preferred embodiments shown and described herein. It should be noted that the illustrated rotor shaft 730, when fully assembled, contains two shaft portions 790 and 785 adjacent to each slanted sidewall 225 and 230 and an adjacent medium cutter portion 704 such that uncrushed material is unobstructively fed from the hopper 105 and into the path of medium blade portion 740. That is, uncrushed material entering the blade portion of the apparatus via the sidewalls 225 and 230 will enter the path of the medium cutter blades 740 rather than small cutter blades 760; thus, the effective lifespan of the small blades 760 is extended.

An advantage of the rotor shaft and blade assembly 502 is the fact that both the large and medium blade portions 750 and 740 are symmetrical, thereby enabling the rotor shaft 530 to be run in both directions with equal cutting efficacy and as a result, extending the time between required maintenance of the blades. Furthermore, since the cutter half portions 706 and 704 are easily coupled and decoupled to/from the rotor shaft 730 with SHCSs, maintenance of the rotor shaft and blade assembly 502 is very quick and easy.

For example, if one of the large blade portions 750 becomes damaged, a maintenance worker merely needs to replace one cutter half portion 706 without disrupting any other blade portions or the rotor shaft and blade assembly 502. As another example, when a small cutter tooth 760 becomes damaged, a maintenance worker merely detaches the particular small cutter rail 714 containing the damaged small cutter tooth 760 and replaces the same without disrupting any other components of the rotor shaft and blade assembly 502. Therefore, not only does the configuration of the rotor shaft and blade assembly 502 provide more time in between required maintenance operations (i.e., due to the capability of running the rotor in both directions), but during those times when maintenance is required, it can be performed with minimal disruption, cost and down-time.

Yet another advantage of the shape of the small teeth 760 is that they are symmetrical and square in shape such that more material may flow between individual cutting teeth 760 for granulation. This is a marked improvement over a saw-toothed configuration.

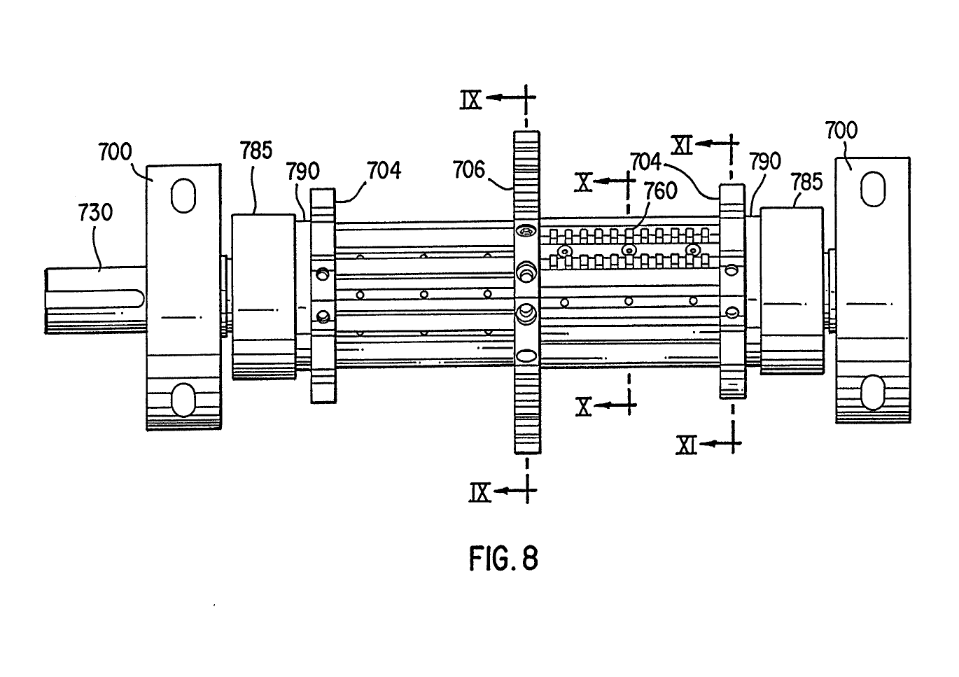

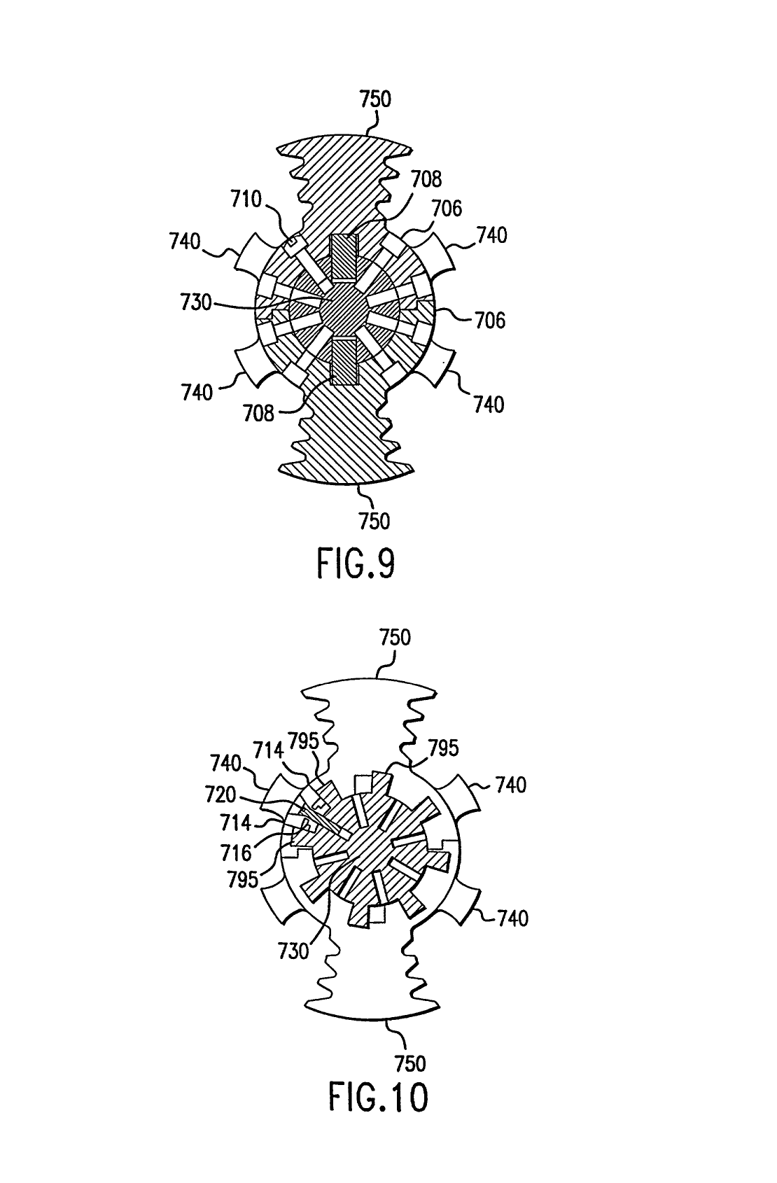

Turning now to FIG. 8, a plan view of a partially assembled rotor shaft and blade assembly 502, as described in FIG. 7, is depicted. Like components are designated with like numerals and will not be discussed further in connection with FIG. 8. Three cross sections are identified; IX-IX, X-X and XI-XI. Each of these will be respectively discussed in greater detail in connection with FIGS. 9, 10 and 11.

Turning now to FIG. 9, a view taken along line IX-IX of FIG. 8 is depicted. Section IX-IX is a cross-sectional view taken through the large cutter half portions 706. As described above, there are two large cutter half portions 706 coupled to rotor shaft 730 and each large cutter half portion 706 contains a large blade portion 750. Also depicted are the two cutter drive keys 708 and one large SHCS 710. The cutter drive keys 708 ensure that large cutter half portions 706 are coupled to rotor shaft 730 in a predetermined manner with respect to the medium cutter halves 704 and the small cutter rails 714. The predetermined couplings are such that the medium cutter blades 740 in combination with the large cutter blades 750 and the small cutter teeth 760 are formed in a staggered formation for more effective cutting action.

As shown in FIG. 10, the small cutter rails 714 are located between the flange portions 795 of the rotor shaft 730. As described in connection with FIG. 7, the small cutter rails 714 are affixed to the rotor shaft 730 in pairs with a cutter retaining plate 716 and a cutter retaining wedge 718. The assembly is then affixed to the rotor shaft 730 with wedge retaining screws 720 in three places for each pair of cutter rails 714. As described above, the small cutting teeth 760 are positioned in a predetermined manner onto the rotor shaft 730. Furthermore, if a particular rail 714 becomes damaged, it is easily removed and replaced without disrupting the other rails 714 and the other cutting blades 740 and 750.

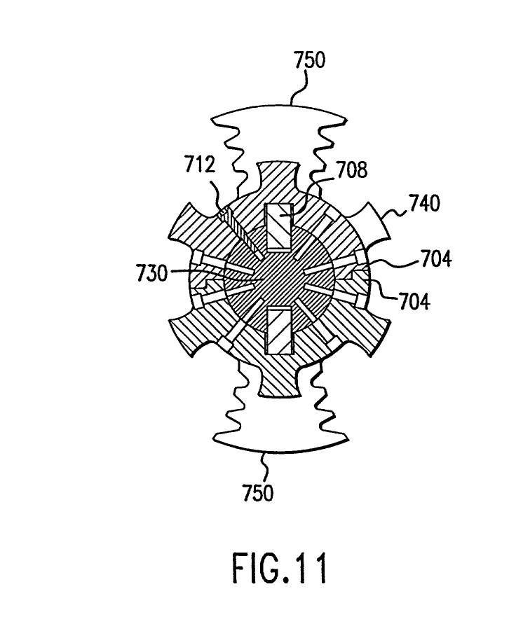

As shown in FIG. 11, the medium cutter half portions 704 are assembled onto the rotor shaft 730 in a predetermined manner with two cutter drive keys 708 such that the medium blade portions 740 are located in a predetermined position with respect to both the large blade portions 750 and the small cutter teeth 760 (as described in FIG. 10). Each medium cutter half portion 704 is affixed to the rotor shaft 730 with four medium SHCSs 712, for a total of sixteen medium SHCSs 712 on a fully assembled rotor shaft and blade assembly 502. FIG. 11 depicts one such SHCS 712 for exemplary purposes. As noted above, the present invention should not be limited to the details of the preferred embodiments shown and described herein.

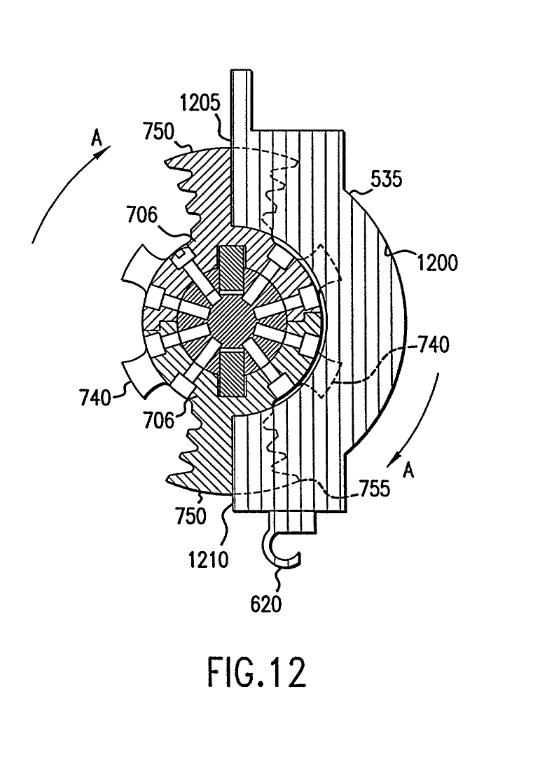

Turning to FIG. 12, a view like FIG. 9 showing a large cover member 535 is depicted. During operation, the cover member 535 is mounted within the three-blade granulator apparatus 100 such that it sits just beneath the large cutter half portions 706. That is, rotating FIG. 12 by 90° such that cover member 535 is on the bottom provides an accurate representation of the relative positions of the cover member 535 and the large cutter portions 706 during operation.

During normal operation, the large blade portions 750 are rotated, e.g., in direction A. The large blade portions 750 are used primarily for breaking down larger pieces of material into smaller pieces of material. The cover member 535 ensures that any material crushed by the large blade portions 750 and that has been forced into the opening 1205 will be pushed out of the opening 1210 by the blade portion 750 running up against the interior wall 1200 of the cover member 535.

Once the material has been forced out of the opening 1210, it will be further crushed by either one of the blade portions 750 and 740, where the above-described process will be repeated, until the material is small enough to be crushed by the small cutter teeth 760 for fine crushing. Once the material has been finely crushed by the small cutter teeth 760, the material drops into a material storage portion such as the one referred to in connection with FIG. 1.

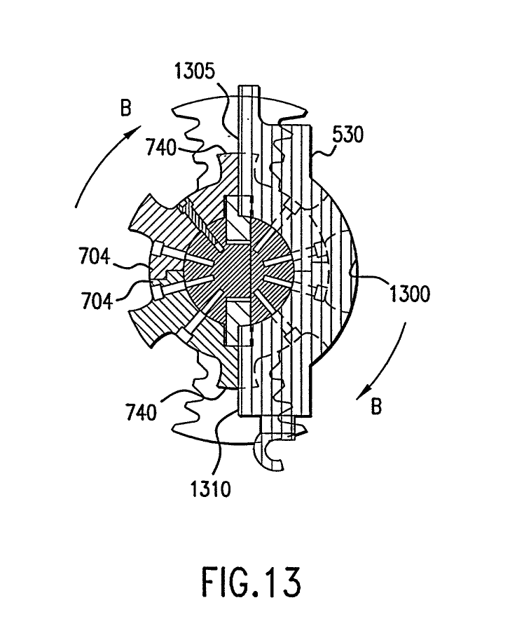

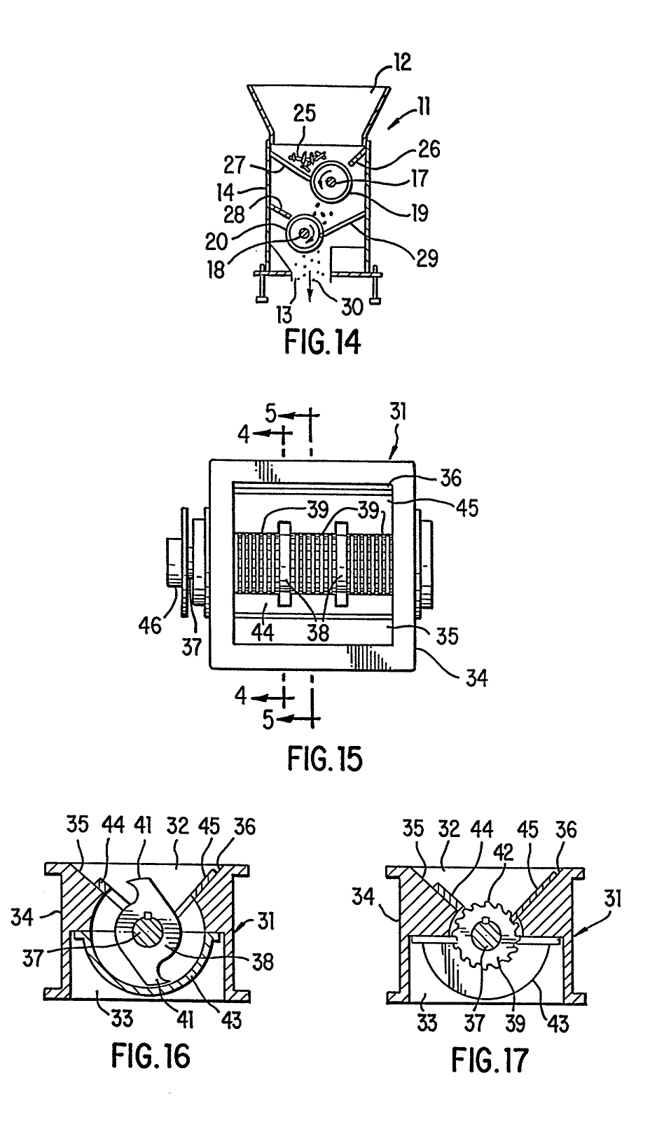

Turning now to FIG. 13, the operation of the medium cover member 530 with regard to medium sized pieces of material is identical to that of the large cover member 535 with regard to large pieces of material (as described above in connection with FIG. 12).

FIG. 18 depicts a perspective view of an assembled granulator 1800 according to a preferred embodiment of the present invention. The granulator 1800 includes a hopper 1805 for feeding material into a rotor shaft and blade assembly 502 situated in an interior portion of the granulator 1800. The granulator 1800 also includes a storage portion 1810 located below the rotor shaft and blade assembly 502 to receive and temporarily store the granulated material. The granulator 1800 also includes four wheels 1815 for a degree of mobility and a granulator motor 104 for rotating the rotor shaft and blade assembly 502 when the two are coupled together, such as, for example, using a pair of pulleys 1820 and 1825 and a drive belt 1830.

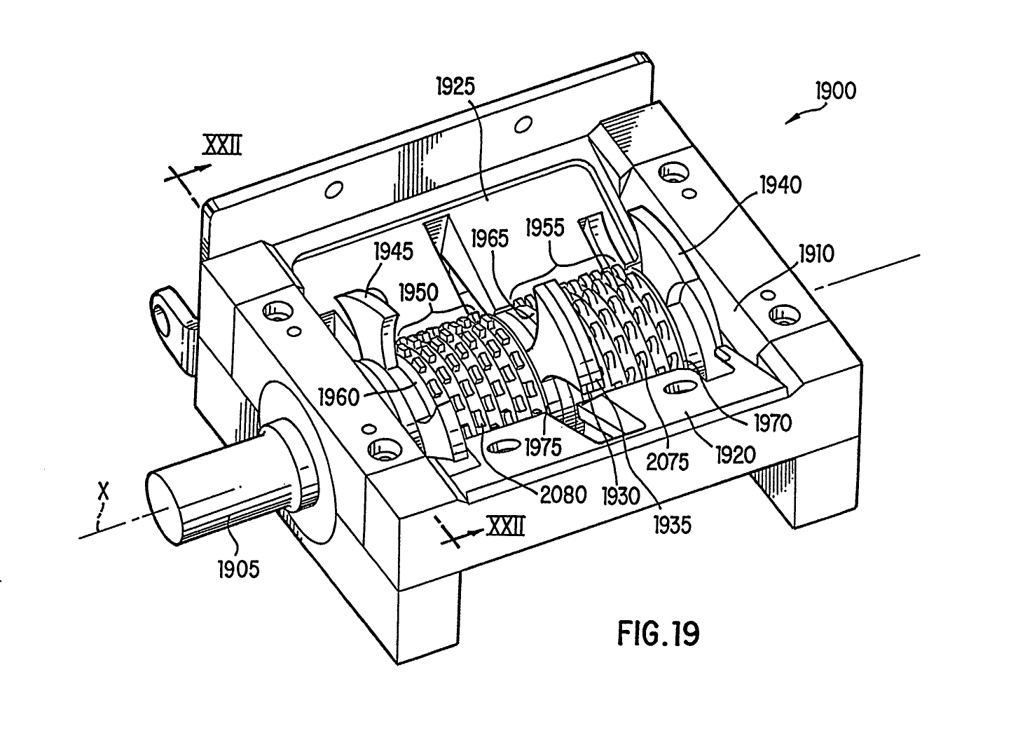

Turning to FIG. 19, a perspective view of a cutting chamber 1900 is illustrated. The cutting chamber 1900 contains a shaft 1905 having an axis X running in a generally horizontal direction. A central portion of the shaft 1905 is hexagonal, as will be described more fully below. Slanted sidewalls 1910 on both sides of the cutting chamber 1900 assist with directing material to be granulated into the path of the blades. In addition, front and rear slanted wall 1920, 1925 assist with directing material to be granulated toward the blades.

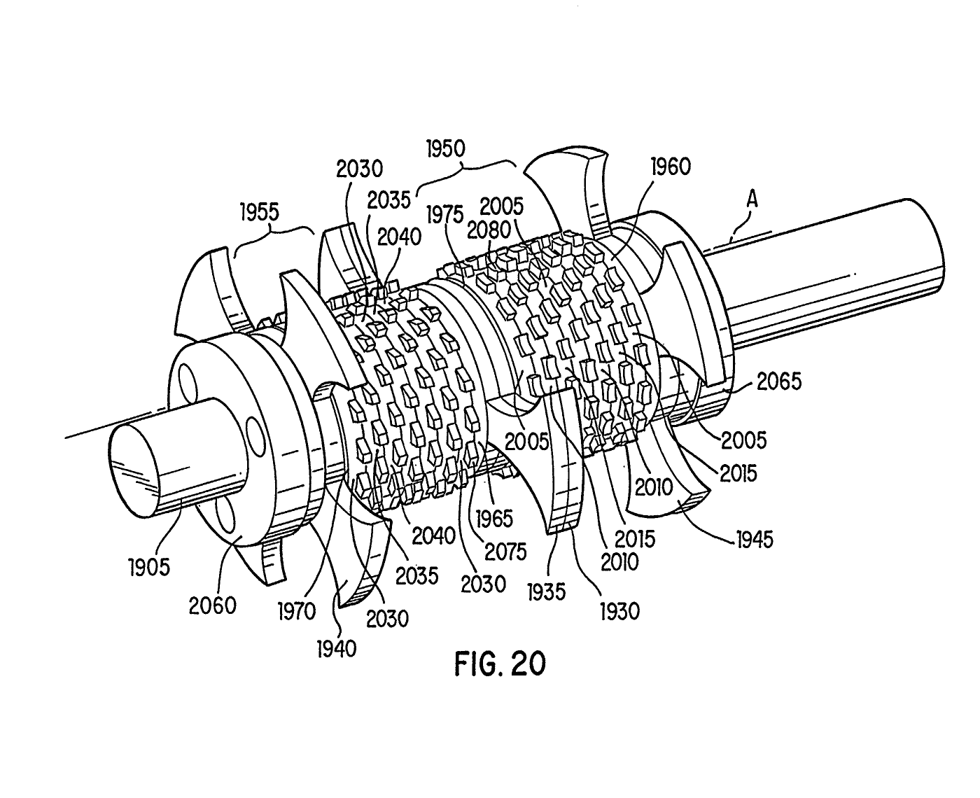

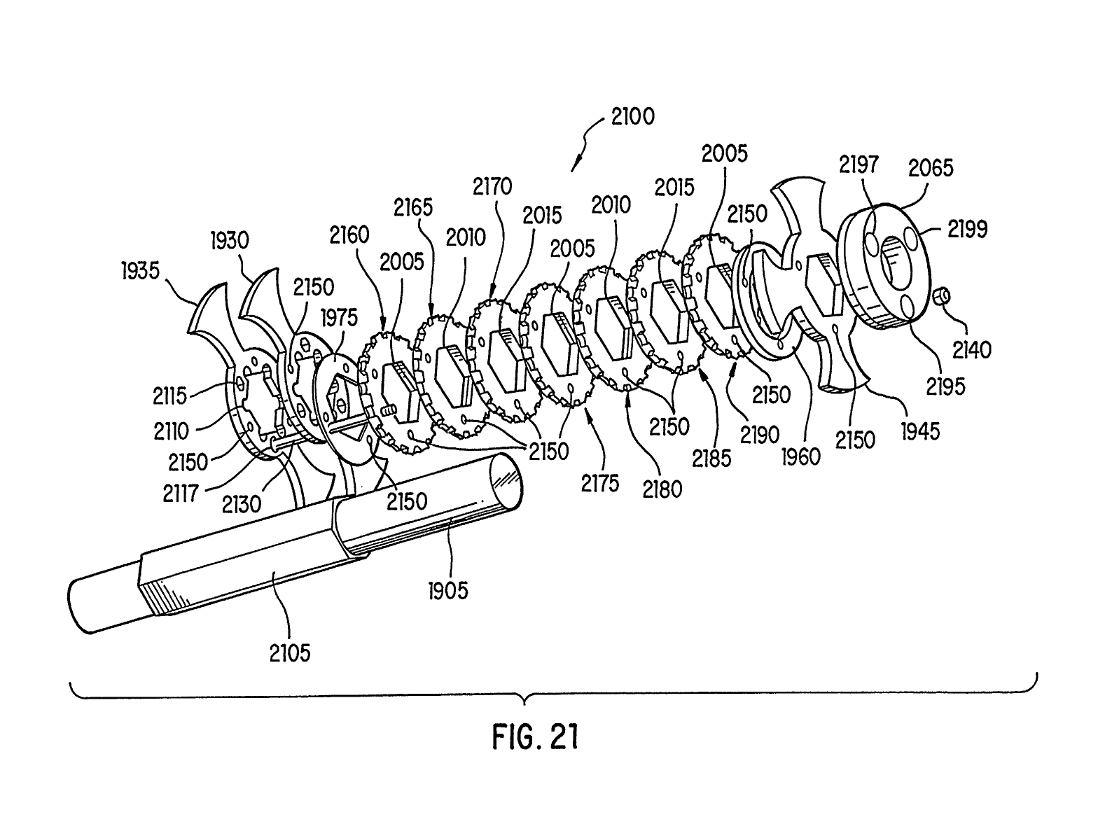

The rotor shaft assembly (FIGS. 20, 21) within the cutting chamber 1900 is depicted generally, from left to right, as containing a first medium cutter 1945 having four symmetrical cutting surfaces spaced equally around the circumference of the cutter 1945. A spacer 1960 is directly adjacent to the first medium cutter 1945 for spacing the first medium cutter 1945 from the first section of small cutters 1950. The first section of small cutters 1950 contains seven small cutter discs. Each of the seven small cutter discs are identical, however, they are oriented on the hexagonal portion of the shaft 1905 in three distinct positions, as will be described more fully below. The cutting teeth 2080 of the first section of small cutters 1950 are symmetrical and squared in shape so as to enable more material to be granulated.

Adjacent to the first section of small cutters 1950 is a second spacer 1975 spacing the first section of small cutters 1950 from two large cutters 1930, 1935. The large cutters 1930, 1935 are identical to each other, each one containing two symmetrical cutting surfaces located at opposite ends of the cutter from one another, however; they are placed on the hexagonal portion (2105 of FIG. 21) of the shaft 1905 in reverse order with respect to each other, as will be described more fully below. On the far side of the large blades 1930, 1935 is a third spacer 1965 for spacing the large cutters 1930, 1935 from the second section of small cutters 1955. Similarly to the first section of small cutters 1950, the second section of small cutters 1955 contains seven identical cutter discs. The cutting teeth 2075 of the second section of cutters 1955 are saw-tooth shaped.

Adjacent to the second section of small cutters 1955 is a fourth spacer 1970 for spacing the second section of small cutters 1955 from a second medium cutter 1940. The general operation of the FIG. 19 cutting chamber 1900 is similar to that of the cutting chamber described in connection with FIGS. 1-13 and will not be repeated here.

Turning to FIG. 20, a perspective view of a rotor shaft assembly of the FIG. 19 cutting chamber is depicted from a bottom side of the assembly. Like features of both FIGS. 19 and 20 are represented with like symbols and will not be repeated here. A right shaft lock 2060 and a left shaft lock 2065 are respectively depicted on left-most and right-most portions of FIG. 20.

The first and second small cutter sections 1950, 1955 of FIG. 19 are depicted here in greater detail. Beginning with the left side of FIG. 20, the second section of small cutters 1955 is depicted as being between the second medium cutter 1940 and the two large cutters 1930, 1935. In this embodiment of the invention, the second section of small cutters 1955 is made up of seven individual cutter discs adjacent to one another on the hexagonal portion 2105 (of FIG. 21) of the shaft 1905.

Each of the cutting teeth 2075 of the second section of cutters 1955 is saw-tooth shaped, however, they need not be so. That is, the cutting teeth 2075 may be any shape that enables the desired end result. As described above, each of the seven cutter discs of the second section of small cutters 1955 is identical to each other and are placed onto the hexagonal portion 2105 of the shaft 1905 in three different orientations so that the cutting teeth 2075 are staggered on the shaft 1905. In addition, the cutting teeth 2075 are positioned on a right side of each cutter disc, thereby inherently introducing a space between cutting teeth 2075 of adjacent cutter discs.

Still referring to FIG. 20, turning to the right side of the shaft 1905, the first section of small cutters 1950 is depicted. Each of the cutting teeth 2080 of the second section of small cutters 1950 is squared in shape, however, they need not be so. Cutting teeth 2080 may be any shape that enables the desired end result. The first section of small cutters 1950 is made up of seven individual cutting discs arranged adjacent to one another on the hexagonal portion 2105 of the shaft 1905 in three different orientations so that the cutting teeth 2080 are staggered on the shaft 1905. In addition, the cutting teeth 2080 are positioned on a right side of each cutter disc, thereby inherently introducing a space between cutting teeth 2080 of adjacent cutter discs. It should be readily apparent that the cutting teeth 2080 need not be located on the right side of each cutter disc, but may be located on the left side or in the middle of the cutter disc.

The horizontally running axis A of FIG. 20 enables one to visualize the three different orientations with which the cutter discs are placed onto the hexagonal portion 2105 of the axis 1905. Looking to the right side of FIG. 20 (the first section of small cutters 1950), one can see that the orientation of cutter disc 2005 is different from the orientation of cutting disc 2010, which is different still from the orientation of cutter disc 2015. These three cutter discs 2005, 2010, 2015 illustrate the three different orientations for the cutter discs of the first section of small cutters 1950. Adjacent to the aforementioned third cutter disc 2015 is a repeat of the orientation of the first cutter disc 2005, and so on, until all seven cutter discs are located onto the hexagonal portion 2105 of shaft 1905. When all seven cutter discs are on the hexagonal portion 2105 of the shaft 1905, three of the discs are oriented like disc 2005, two of the discs are oriented like disc 2010 and two of the discs are oriented like disc 2015. The orientation order from left to right is 2005, 2010, 2015, 2005, 2010, 2015 and 2005, thereby creating a staggered effect of cutting teeth 2080.

The staggered effect of cutting teeth 2075 of the second section of small cutters 1955 is obtained in a manner identical to that described above for the first section of small cutters 1950. That is, from left to right, the seven cutter discs that contain the saw-tooth shaped cutters 2075 are arranged on the hexagonal portion 2105 of the shaft 1905 in the orientation order 2030, 2035, 2040, 2030, 2035, 2040 and 2030.

Turning now to FIG. 21, an exploded view 2100 of a portion of the FIG. 20 rotor shaft assembly is depicted. Specifically, FIG. 21 shows only the components of the right side of FIG. 20, however, it should be readily understood that the assembly of the left side of FIG. 20 is identical to that of the right side.

Beginning on the left-most side of FIG. 21, the shaft 1905 is depicted as having a hexagonal portion 2105 onto which the large cutters 1930, 1935, the cutter discs, the spacers and the first medium cutters 1945 are assembled. It should be noted that the shaft 1905 may have a portion with greater than six sides (e.g., octagonal, etc.). The greater the number of sides on the shaft 1905, the greater the flexibility for orienting the cutting teeth in a staggered formation. The two large cutters 1935, 1930 are shown adjacent to one another. The large cutters 1935, 1930 are actually identical to one another, but are coupled to the hexagonal shaft 2105 in reverse order. Each large cutter 1935, 1930 contains two cutting blades on opposite sides of one another and each blade is positioned on the hexagonal shaft 2105 such that the two cutting blades are in phase with one another. In a preferred embodiment, the two large cutters 1935, 1930 are welded to the hexagonal shaft 2105. Each large cutter 1935, 1930 also contains a cutout portion 2110 at each corner of the hexagonal center. These cutouts 2110 increase the strength and durability of the large cutters 1935, 1930 which is desirable since the large cutters are intended to break down the largest pieces of the material to be granulated and, therefore, are subject to the most grueling conditions. The large cutters 1935, 1930 also contain three circular holes 2150 for passing a cylindrical stabilizer rod (e.g., rod 2130), as will be described more fully below.

Adjacent to the large cutters 1935, 1930 is a spacer 1975 having a hexagonal center for fitting onto hexagonal shaft 2105. The spacer 1975 contains three circular holes 2150 for passing a cylindrical stabilizer rod (e.g., rod 2130).

Adjacent to the spacer 1975 is a first cutter disc 2160 depicted as being in a first orientation 2005 for mounting onto the hexagonal shaft 2105. The next cutter disc 2165 is depicted as being in a second orientation 2010 and the third cutter disc 2170 is in a third orientation 2015 for mounting onto the hexagonal shaft 2105. The fourth cutter disc 2175 is depicted as having the same orientation 2005 as the first cutter disc 2160. The fifth cutter disc 2180 is depicted as having the same orientation 2010 as the second cutter disc 2165. The sixth cutter disc 2185 is depicted as having the same orientation 2015 as the third cutter disc 2170 and the seventh cutter disc 2190 is depicted as having the same orientation 2005 as the first cutter disc 2160 and the fourth cutter disc 2175. Each cutter disc 2160-2180 is depicted as having 18 cutting teeth, however, the exact number of cutting teeth is not critical and may be increased or decreased as desired. In addition, each cutter disc 2160-2180 contains three circular holes 2150 for passing a cylindrical stabilizer rod (e.g., rod 2130).

Adjacent to the cutter discs 2160-2190 is a spacer 1960 for creating a space between the cutter discs 2160-2190 and the first medium cutter 1945. The spacer contains three circular holes 2150 for passing a cylindrical stabilizer rod (e.g., rod 2130). Adjacent to the first medium cutter 1945 is the left shaft lock 2065 for passing a stabilizer rod (e.g., rod 2130). The left shaft lock 2065 also has three receptacles 2195, 2197, 2199 for passing the stabilizer rod 2130 and also for receiving three hex nuts 2140 to lock the cutters and spacers 1935-1945 together. Three stabilizer rods (e.g., rod 2130) are respectively passed through each of the cutters and spacers 1935-1945, via circular holes 2150, and a hex nut 2140 is bolted down on either end of each rod 2130 (i.e., via hex holes 2195, 2197 and 2199 on the left shaft lock 2065 and also via the corresponding hex holes, including hex holes 2117 and 2115, of the left-most large cutter 1935) to secure the cutters and spacers 1935-1945 in place. Similarly, three stabilizer rods and six hex nuts are used between the right shaft lock 2060 and the right-most large cutter 1930 in order to secure the left side of the FIG. 21 assembly.

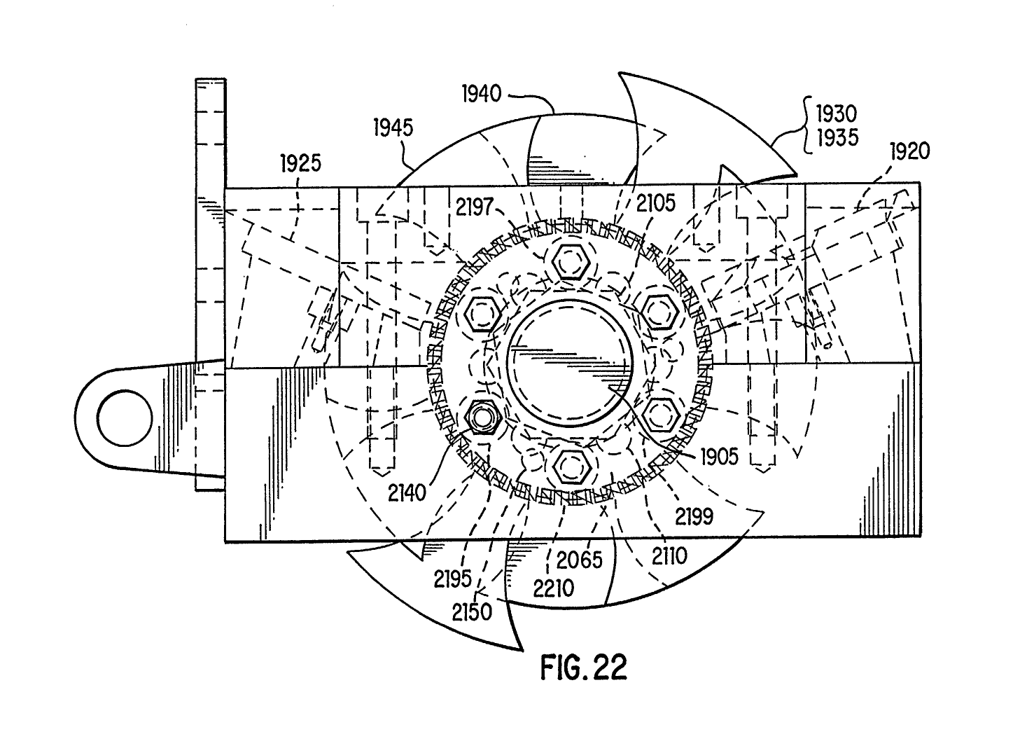

Turning to FIG. 22, a cross sectional view taken along line XXII of the FIG. 19 cutting chamber is depicted. Front and rear slanted walls 1920, 1925 are respectively depicted on right and left sides of FIG. 22 for helping to direct material into the path of the cutters. Large cutters 1930, 1935 are depicted as being in phase with one another, as described above. The first medium cutter 1945 is depicted as being out of phase with the large cutters 1930, 1935 and the second medium cutter 1940 is depicted as being out of phase with both the large cutters 1930, 1935 and the first medium cutter 1945. The out-of-phase relationship between the first medium cutter 1945, the second medium cutter 1940 and the large cutters 1930, 1935 creates less of a demand for power during the granulating process since the motor (not shown) is not attempting to granulate material on multiple blades at the same time. Rather, the blades, as well as the demand for power by the granulator, are staggered, thereby enabling more efficient operation of the granulator.

FIG. 22 also shows a cross sectional view 2210 of the first and second small cutter sections 1950, 1955; however, their orientations and individual phase relationships are more easily viewed from FIGS. 19-21. Also depicted in FIG. 22 are the three receptacles 2195, 2197, 2199 in the left shaft lock 2065, the three circular holes 2150 passing through each of the cutters and spacers of FIGS. 19-21, and also the hex nut 2140 from FIG. 21. FIG. 22 also depicts the hexagonal shaft portion 2105 of the shaft 1905 and the six cutout portions 2110 of the large cutters 1930, 1935.

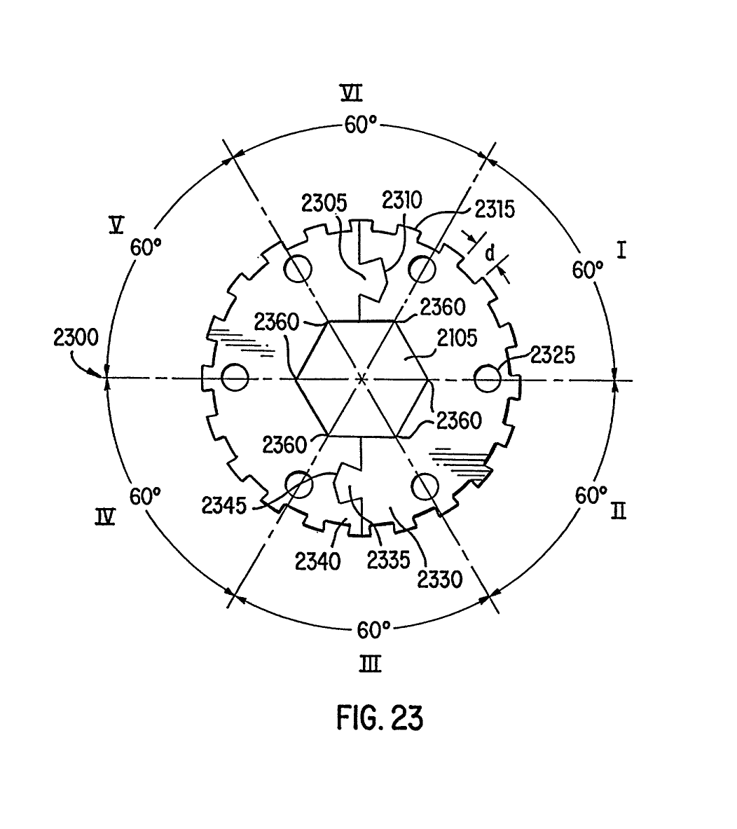

Turning to FIG. 23, a small cutter disc 2300 which may be used in either the first or second section, or both, of small cutters 1950, 1955 is depicted in accordance with another embodiment of the invention. The cutter disc 2300 has two halves 2340, 2330 which may be interlocked together as shown or simply joined together without being interlocked and affixed onto a shaft such as the hexagonal portion 2105 of the shaft 1905 (of FIG. 21). In addition, the cutter disc 2300 need not have two halves 2340, 2330, but rather it may be a one-piece disc that slides onto the hexagonal shaft 2105.

Each of the two disc halves 2340, 2330 has an interlocking feature 2305, 2335 located within a respective recessed portion 2310, 2345 in the other disc half 2330, 2340. The two-piece interlocking structure of the disc halves 2340, 2330 allows for the assembly/disassembly of a particular disc (e.g., a disc with a damaged cutter) on the hexagonal shaft 2105 without disrupting the other discs on the shaft 2105. When the disc halves 2340, 2330 are joined together, they form a hexagonal center which fits onto the hexagonal shaft 2105.

Each disc half 2340, 2330 may also contain three circular holes 2325 located near an outer peripheral edge of each disc half 2340, 2330. Each circular hole 2325 is adapted to receive a stabilizer rod (not shown) for helping to maintain the discs 2300 stationary while mounted on the shaft 2105. Furthermore, each circular hole 2325 is located such that it is aligned with one of the six angular intersections of the hexagonal center, as depicted in FIG. 23.

In addition, when the two disc halves 2340, 2330 are joined together, they form a total of twenty symmetrical cutting teeth 2315 in that they can cut in either direction with equal effectiveness. In addition, the spacing d between the cutting teeth 2315 and the squared shape of the cutting teeth 2315 allow for the capturing of greater amounts of material between the teeth 2315 for granulation. The cutting teeth 2315 are located around the peripheral edge of the cutter disc 2300, and relative to the hexagonal center such that each of the six angular intersections (of the hexagonal sides) is aligned with one of three different positions relative to each tooth 2315. The effect of this configuration is to allow for the cutting teeth 2315 to be arranged on the shaft 2105 in a staggered formation and in more positions than the hexagonal shaft 2105 alone would allow.

For example, as depicted in FIG. 23, the cutter disc 2300 is divided into six adjacent 60° portions I-VI. Each 60° portion is unique (i.e., unique with respect to the number of cutting teeth 2315 included within the 60° portion and/or the position of the cutting teeth 2315 within that 60° portion with respect to the angular portions 2360 of the hexagonal shaft 2105 which define that 60° portion) with respect to the two adjacent 60° portions directly following it when the blade is rotated in either a clockwise or counter-clockwise direction. As can be seen, 60° portion I is unique with respect to 60° portions II and III. However, 60° portion I is identical to 60° portion IV. It should be apparent from FIG. 23 that 60° portion II is identical to 60° portion V and that 60° portion III is identical to 60° portion VI. This feature enables the staggered formation referred to above in FIGS. 19-22 when three adjacent discs 2300 are respectively placed onto the hexagonal portion 2105 of the shaft 1905 in three different orientations.

An improved granulator apparatus has been disclosed for use with crushing, e.g., industrial plastic material. The apparatus has two slanted sidewalls 225 and 230 (of FIGS. 2 and 3) angled at approximately 10-20 degrees from a perpendicular of the axis A for the rotor shaft 730. The slanted sides of the sidewalls 225, 230 cause the material to be fed by gravity into the path of medium cutter blade portions 740 on both sides of the rotor shaft and blade assembly 502. In addition, the shaft portions 785 and 790 provide an unobstructed path through which the uncrushed material may travel to be crushed by the medium blade portions 740. Furthermore, the symmetrical shape of the cutting blades 740, 750 and 760 and the simplified manner with which the cutter half portions 704 and 706 and small cutter rails 714 are attached to and removed from the rotor shaft 730 makes maintenance of the crushing apparatus extremely quick and efficient.

In addition, the disclosed granulator apparatus has been depicted as having an alternative rotor shaft design in which there are first and second medium cutters 1945, 1940 on either end of a hexagonal portion 2105 of a shaft 1905 and two large cutters 1930, 1935 at the center of the hexagonal shaft 2105. In between the first medium cutter 1945 and the large cutters 1930, 1935 is a first section of small cutters 1950 and in between the large cutters 1930, 1935 and the second medium cutter 1940 is a second section of small cutters 1955. As depicted the blades of the first and second small cutter sections 1950, 1955 are different from each other, however, they may be the same type of blade. In addition, each of the first and second small cutter sections 1950, 1955 may include a mixture of different shaped cutting teeth and need not all be the same within a section 1950, 1955. In addition, although seven cutter discs have been described in connection with the first and second small cutter sections 1950, 1955, any number of cutter discs may be used. Furthermore, while only two medium cutters 1945, 1940 and two large cutters 1935, 1930 are described, it should be readily apparent that any number of medium cutters and large cutters may be used. In addition, a staggered formation allowing for three distinct blade orientations of the small cutters 1950, 1955 on the hexagonal shaft 2105 is described. Furthermore, the large cutters 1930, 1935 are in phase with each other but are out of phase with both the first and second medium cutters 1945, 1940. Moreover, the first and second medium cutters 1945, 1940 are out of phase with one another.

The above description and drawings are only illustrative of preferred embodiments of the present invention, and are not intended to limit the present invention thereto. For example, the embodiments shown depict two large blades 750, and four medium cutter half portions 704, for a total of twelve medium blades 740, and thirty-two small cutter rails 714, each containing eleven teeth, for a total of 352 small cutter teeth 760. It should be readily apparent that more or less, or different combinations of cutter teeth, whether they be large, medium or small, may be used without deviating from the spirit or scope of the present invention. In addition, although large and medium cutter half portions 706 and 704 are depicted for exemplary purposes, it should be apparent that any number of fractional cutter portions may be substituted with similar efficacy. Any subject matter or modification which comes within the spirit and scope of the following claims is to be considered part of the present invention.

What is claimed as new and desired to be protected by Letters Patent of the United States is:

1. An apparatus for processing material, said apparatus comprising:
a cutting chamber having an interior portion and an exterior portion;
a rotor shaft mounted in said interior portion of said cutting chamber, said rotor shaft having an axis running in a generally horizontal direction;
a first plurality of cutters extending radially from said rotor shaft;
a second plurality of cutters extending radially from said rotor shaft, each one of said second plurality of cutters extending radially from said rotor shaft a distance less than each one of said first plurality of cutters, wherein
approximately a first half of said second plurality of cutters is positioned on said rotor shaft between a first one and a second one of said first plurality of cutters; and wherein
approximately a second half of said second plurality of cutters is positioned on said rotor shaft between said second one and a third one of said first plurality of cutters.

2. The apparatus of claim 1, wherein said first plurality of cutters comprises at least one large cutter and at least one medium cutter.

3. The apparatus of claim 2, wherein said first plurality of cutter comprises two large cutters adjacent to one another approximately at a center of said rotor shaft and two medium cutters located at opposite ends of said rotor shaft from each other.

4. The apparatus of claim 3, wherein each of said two large cutters comprise at least two symmetrical blade portions.

5. The apparatus of claim 3, wherein each of said medium cutters comprise four symmetrical blade portions.

6. The apparatus of claim 1, wherein said second plurality of cutters comprises a plurality of small cutters.

7. The apparatus of claim 6, wherein a plurality of said small cutters are affixed to a multiple cutter assembly, said multiple cutter assembly being mountable onto said rotor shaft.

8. The apparatus of claim 6, wherein said second plurality of cutters comprises a plurality of cutter teeth formed on a peripheral surface of a cutter disc formed on said rotor shaft.

9. The apparatus of claim 6, wherein said second plurality of cutters comprises a plurality of cutter discs formed on said rotor shaft, each of said cutter discs having a plurality of cutter teeth formed on a peripheral surface.

10. The apparatus of claim 9, wherein each of said plurality of cutter discs contains at least ten of said cutter teeth formed on said peripheral surface.

11. The apparatus of claim 10, wherein each of said plurality of cutter discs contains eighteen cutter teeth formed on said peripheral surface.

12. The apparatus of claim 9, wherein each of said cutter teeth has a symmetrical shape.

13. The apparatus of claim 12, each of said cutter teeth are square shaped.

14. The apparatus of claim 9, wherein each of said cutter teeth has a saw-tooth shape.

15. The apparatus of claim 9, wherein at least one of said cutter discs formed on said rotor shaft comprises at least two portions.

16. The apparatus of claim 15, wherein said at least one cutter disc contains an interlocking feature on each of said at least two portions for interlocking when said cutter disc is formed onto said shaft.

17. The apparatus of claim 9, wherein said plurality of cutter discs are formed on said rotor shaft so as to form a staggered pattern of said cutter teeth.

18. The apparatus of claim 17, wherein each of said plurality of cutter discs are identical to one another and, wherein each cutter disc may be formed on said rotor shaft in at least three different orientations so as to enable said staggered pattern.

19. The apparatus of claim 18, wherein said rotor shaft is hexagonal in shape, and wherein each of said cutter discs contain a hexagonal-shaped inner peripheral surface.

20. The apparatus of claim 9, wherein each of said plurality of cutter teeth on said peripheral surface are less wide than said peripheral surface.

21. The apparatus of claim 1 further comprising at least one spacer mounted on said rotor shaft, said spacer creating a space between at least one of said first one and said second one of said first plurality of cutters and at least one of said first half and said second half of said second plurality of cutters.

22. The apparatus of claim 1, wherein each of said first plurality of cutters further comprises a fractional cutter portion, each of said fractional cutter portions being mountable onto said rotor shaft.

23. The apparatus of claim 22, wherein each of said fractional cutter portions comprise a cutter half portion.

24. The apparatus of claim 23, wherein said first plurality of cutter half portions comprises a plurality of large cutter half portions and a plurality of medium cutter half portions.

25. The apparatus of claim 24, wherein each of said large cutter half portions and medium cutter half portions contains at least one cutter blade portion.

26. The apparatus of claim 25, wherein each of said cutter blade portions are symmetrical.

27. The apparatus of claim 6, wherein each of said small cutters comprises cutting teeth.

28. The apparatus of claim 27, wherein each of said cutting teeth are symmetrical.

29. The apparatus of claim 1, wherein said first and second plurality of cutters are staggered along said rotor shaft.

30. The apparatus of claim 29, wherein at least one cutter of said first and second plurality of cutters is coupled to said rotor shaft via a keying device to ensure said cutter is positioned on said rotor shaft in a predetermined manner.

31. The apparatus of claim 1 further comprising a sidewall on either side of said rotor shaft, each sidewall being angled between approximately 10° and 20° with respect to a perpendicular of said axis.

32. The apparatus of claim 31, wherein at least one of said first plurality of cutters is in relatively close proximity to at least one of said angled sidewalls such that said angled sidewall assists in feeding a material to be crushed toward said at least one cutter without said material first contacting any of said second plurality of cutters.

33. A rotatable blade assembly, comprising:
a rotor shaft;
a first plurality of cutters extending radially from said rotor shaft;
a second plurality of cutters extending radially from said rotor shaft, each one of said second plurality of cutters extending radially from said rotor shaft a distance less than each one of said first plurality of cutters, wherein
approximately a first half of said second plurality of cutters is positioned on said rotor shaft between a first one and a second one of said first plurality of cutters; and wherein
approximately a second half of said second plurality of cutters is positioned on said rotor shaft between said second one and a third one of said first plurality of cutters.

34. The assembly of claim 33, wherein said first plurality of cutters comprises a plurality of large cutters and a plurality of medium cutters.

35. The assembly of claim 33, wherein said second plurality of cutters comprises a plurality of small cutters.

36. The assembly of claim 35, wherein a plurality of said small cutters are affixed to a multiple cutter assembly, said multiple cutter assembly being mountable onto said rotor shaft.

37. The assembly of claim 33, wherein each of said first plurality of cutters further comprises a fractional cutter portion, each of said fractional cutter portions being mountable onto said rotor shaft.

38. The assembly of claim 37, wherein each of said fractional cutter portions comprise a cutter half portion.

39. The assembly of 38, wherein said first plurality of cutter half portions comprises a plurality of large cutter half portions and a plurality of medium cutter half portions.

40. The assembly of claim 39, wherein each of said large cutter half portions and medium cutter half portions contains at least one cutter blade portion.

41. The assembly of claim 40, wherein each of said cutter blade portions are symmetrical.

42. The assembly of claim 36, wherein each of said small cutters comprises cutting teeth.

43. The assembly of claim 42, wherein each of said cutting teeth are symmetrical.

44. The assembly of claim 33, wherein said first and second plurality of cutters extend from said rotor shaft such that a staggered cutting action may result.

45. The assembly of claim 44, wherein at least one cutter of said first and second plurality of cutters is coupled to said rotor shaft via a keying device to ensure said cutter is positioned on said rotor shaft in a predetermined manner.

46. The assembly of claim 33, wherein said first plurality of cutters comprises at least one large cutter and at least one medium cutter.

47. The assembly of claim 46, wherein said first plurality of cutter comprises two large cutters adjacent to one another approximately at a center of said rotor shaft and two medium cutters located at opposite ends of said rotor shaft from each other.

48. The assembly of claim 47, wherein each of said two large cutters comprise at least two symmetrical blade portions.

49. The assembly of claim 47, wherein each of said medium cutters comprise four symmetrical blade portions.

50. The assembly of claim 35, wherein said second plurality of cutters comprises a plurality of cutter teeth formed on a peripheral surface of a cutter disc formed on said rotor shaft.

51. The assembly of claim 50, wherein said second plurality of cutters comprises a plurality of cutter discs formed on said rotor shaft, each of said cutter discs having a plurality of cutter teeth formed on a peripheral surface.

52. The assembly of claim 51, wherein each of said plurality of cutter discs contains at least ten of said cutter teeth formed on said peripheral surface.

53. The assembly of claim 52, wherein each of said plurality of cutter discs contains eighteen cutter teeth formed on said peripheral surface.

54. The assembly of claim 51, wherein each of said cutter teeth has a symmetrical shape.

55. The assembly of claim 54, each of said cutter teeth are square shaped.

56. The assembly of claim 52, wherein each of said cutter teeth has a saw-tooth shape.

57. The assembly of claim 51, wherein at least one of said cutter discs formed on said rotor shaft comprises at least two portions.

58. The assembly of claim 57, wherein said at least one cutter disc contains an interlocking feature on each of said at least two portions for interlocking when said cutter disc is formed onto said shaft.

59. The assembly of claim 51, wherein said plurality of cutter discs are formed on said rotor shaft so as to form a staggered pattern of said cutter teeth.

60. The assembly of claim 59, wherein each of said plurality of cutter discs are identical to one another, and wherein each cutter disc may be formed on said rotor shaft in at least three different orientations so as to enable said staggered pattern.

61. The assembly of claim 51, wherein said rotor shaft is hexagonal in shape, and wherein each of said cutter discs contain a hexagonal-shaped inner peripheral surface.

62. The assembly of claim 51, wherein each of said plurality of cutter teeth on said peripheral surface are less wide than said peripheral surface.

63. The assembly of claim 33 further comprising at least one spacer mounted on said rotor shaft, said spacer creating a space between at least one of said first one and said second one of said first plurality of cutters and at least one of said first half and said second half of said second plurality of cutters.

64. A cutter for use with a material crushing apparatus, said cutter comprising: a fractional cutter portion mountable onto a rotor shaft, said fractional cutter portion having at least one symmetrical cutting blade such that said material crushing apparatus may be run with said rotor shaft rotating in either direction.

65. The cutter of claim 64, wherein said fractional cutter portion comprises a cutter half portion.

66. The cutter of claim 64 further comprising at least one cutting ridge on both sides of said at least one symmetrical cutting blade.

67. The cutter of claim 64 further comprising an alignment portion for aligning said cutter onto said rotor shaft in a predetermined manner.

68. The cutter of claim 64, wherein said material crushing apparatus is a granulator apparatus.

69. A cutter for use with a material crushing apparatus, said cutter comprising: a plurality of symmetrical cutting teeth mounted onto a cutting tooth assembly, said cutting tooth assembly being mountable onto a rotor shaft such that said material crushing apparatus may be run with said rotor shaft rotating in either direction.

70. The cutter of claim 69, wherein said material crushing apparatus is a granulator apparatus.

71. A cutting chamber frame assembly for use with a material crushing apparatus, said assembly comprising:
a top chamber plate;
a front chamber plate coupled to said top chamber plate;
a rear chamber plate coupled to said top chamber plate;
a left chamber plate coupled to said top, front and rear chamber plates;
a right chamber plate coupled to said top, front and rear chamber plates, wherein
said front, rear, left and right chamber plates are coupled to form a four-sided polygonal chamber, said top chamber plate being coupled to said four-sided polygonal chamber to form a cover on a top side thereof, and wherein
said front, rear, left and right chamber plates are coupled together via a plurality of respective and corresponding mating slots.

72. The assembly of claim 71 further comprising at least one slanted sidewall coupled to at least one of said left and right chamber plates, said slanted sidewall forming an angle of approximately 10° to 20° with said at least one of said left and right chamber plates.

73. A cutting chamber for use with a granulator apparatus, the cutting chamber comprising:
a rotor shaft and blade assembly; and
a mounting shaft mounted in a generally horizontal position for commonly mounting at least one cover member, wherein the cover member is configured to prevent granulated material from exiting the cutting chamber until said granulated material is in a predetermined state of granulation.

74. A cutter disc, comprising a plurality of cutting teeth on an outer peripheral surface, wherein a given 60° portion of said cutter disc contains a unique number of said cutting teeth and/or a unique position of said cutting teeth within said given 60° portion as compared with at least two other 60° portions immediately preceding and immediately following said given 60° portion.

75. A method of replacing a defective cutter in a granulator apparatus, the method comprising:
decoupling at least one fractional cutter portion containing a defective cutter blade from a rotor shaft and blade assembly; and
coupling a replacement fractional cutter portion to said rotor shaft and blade assembly, wherein only said fractional cutter portion need be removed from said rotor shaft and blade assembly.

76. The method of claim 75, wherein said act of decoupling comprises decoupling at least one cutter half portion.

77. A method of operating a granulator apparatus, the method comprising:
running a rotor shaft and blade assembly in a first rotational direction; and
running said rotor shaft and blade assembly in a rotational direction opposite said first rotational direction without removing and without reconfiguring a blade of said rotor shaft and blade assembly.
